(19) United States
(12) Patent Application Publication
(10) Pub. No.: US 2014/0238214 A1
(43) Pub. Date: Aug. 28, 2014

(54) LABEL DEVICE

(71) Applicant: Gerald Finken, Fargo, ND (US)

(72) Inventor: Gerald Finken, Fargo, ND (US)

(21) Appl. No.: 14/187,727

(22) Filed: Feb. 24, 2014

Related U.S. Application Data
(60) Provisional application No. 61/768,180, filed on Feb. 22, 2013.

(51) Int. Cl. B26D 3/08; B26D 5/08; B65C 9/00

(52) U.S. Cl. CPC B26D 3/085; B65C 9/00; B26D 5/08
USPC 83/886; 83/879

(57) ABSTRACT

A label device may include an inlet system, an outlet system, and a label creation area arranged between the inlet system and the outlet system, including a platform and a cutter assembly arranged above the platform and configured to move through a programmed route to physically delineate a label on label material backed by the platform.

### CROSS-REFERENCE TO RELATED APPLICATIONS

The present application claims priority to U.S. Provisional Application No. 61/768,180 filed on Feb. 22, 2013 entitled Label Printer and Die Cutter, and Systems and Methods for Using Same and U.S. Non-Provisional application Ser. No. 13/774,659 filed on Feb. 22, 2013 entitled System and Method for Labeling Trial Study Materials, the contents of each of which are hereby incorporated by reference herein in their entireties.

### FIELD OF THE DISCLOSURE

The present disclosure relates generally to label devices. More particularly, the present disclosure relates to devices for cutting, scoring, etching, perforating, or otherwise physically delineating label locations on, for example, a sheet of adhesive material with a backing. Still more particularly, the present disclosure relates to on-demand label devices for physically delineating label locations for medical trials including blind studies.

### BACKGROUND

Label creation often involves bulk production of labels by feeding sheets of adhesive material with backing through a platen press or rotary die cutter. In this process, mass production of labels may be performed by feeding a particularly sized roll of material through the press or cutter, which cuts through the adhesive material leaving the backing intact. This approach provides for mass production of a selected size label. In other cases, a computer guided knife blade may be dragged on the material to cut out shapes allowing for different shapes and sizes to be cut but at a slower rate than the above example. Still another example of a label making device is a laser cutter, which allows for different shapes and sizes like the computer guided knife blade without requiring blade changing. This approach, however, is more expensive and may require shielding from laser light and a system for removing fumes or other gases resulting from the process. The sheets or rolls of labels may then be placed in a printer where the printer is programmed or arranged to print within the regions defined by the pre-cut labels.

In the case of clinical trials, it is common to pre-make all of the labels for labeling kits, drug bottles, and instruments, for example. This may include anywhere from dozens to tens of thousands of trial study supply units being prepared for a given study protocol or protocols. In a traditional model, all of the labels for a trial or a significant portion of the trial will be created, approved, and sometimes printed before the trial even begins. Regulatory agencies of one or more countries often must approve all of the labels for a given study before a trial begins. The study drugs are not typically packaged until all of the labels for all of the expected primary and secondary containers have been created, approved, and sometimes printed. As can be imagined, this model results in delay, waste, and inefficiencies. This portion of a clinical trial may be the portion of the study contributing most to study start delays.

### SUMMARY

In one embodiment, a label device may include an inlet system, an outlet system, and a label creation area arranged between the inlet system and the outlet system. The label creation area may include a platform and a cutter assembly arranged above the platform. The cutter assembly may be configured to move through a programmed route to physically delineate a label on a sheet of label material backed by the platform. The programmed route may be a pre-programmed route or it may be responsive to sensors that identify label locations on the label material based on content pre-printed thereon. As such, the label device may be used to create labels on an on-demand basis thereby reducing issues of delay, waste, and other inefficiencies.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is perspective view of an label device, according to some embodiments.

FIG. 2 is a close-up perspective view of an inlet portion of the device of FIG. 1.

FIG. 3 is a close-up perspective view of an outlet portion of the device of FIG. 1.

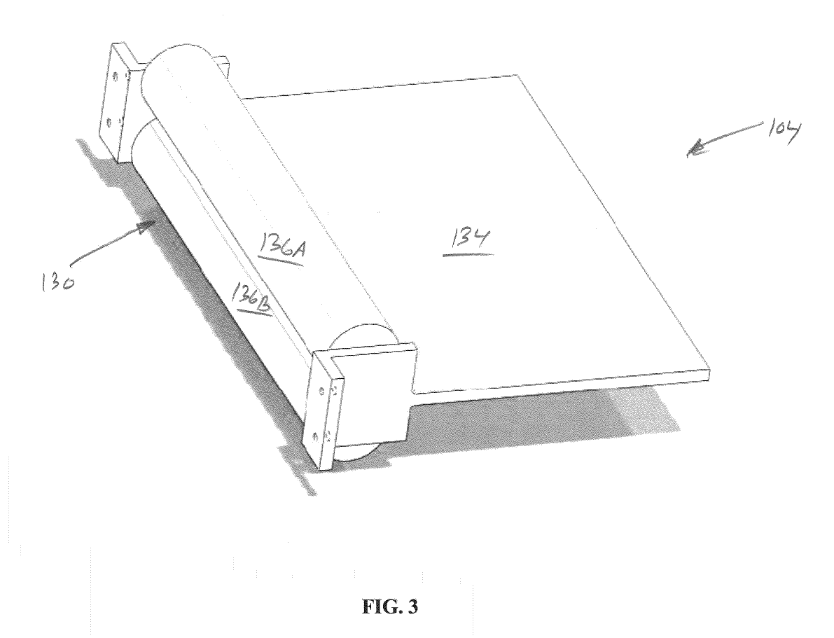

FIG. 4 is a close-up perspective view of a cutter handling system of the device of FIG. 1.

FIG. 5 is a close-up perspective view of a cutter assembly of the device of FIG. 1.

FIG. 6 is a close-up perspective view of a cutting element of the cutter assembly of FIG. 5.

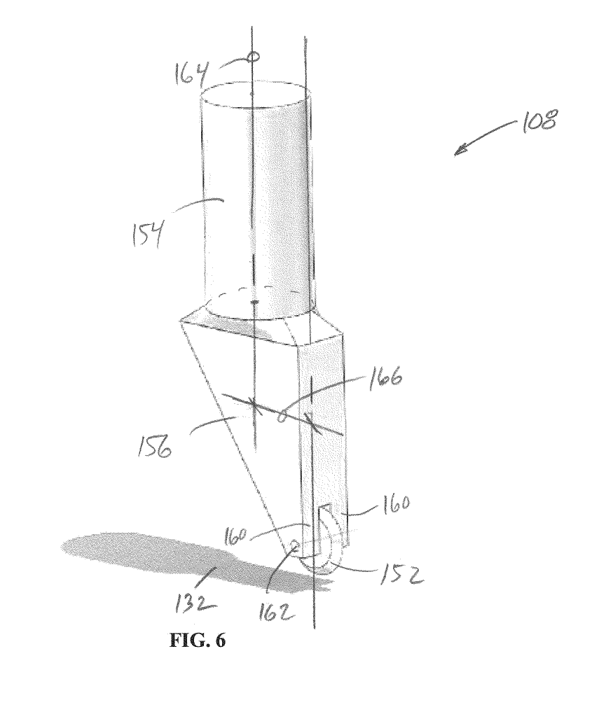

FIG. 7 is a close-up perspective view of another cutter assembly, according to some embodiments.

### DETAILED DESCRIPTION

The present disclosure, in one embodiment, relates to a label device for creating labels on an as-needed basis. The label device may be adapted to receive adhesive material in the form of one or more sheets or a roll of adhesive material having a backing and having pre-printed content on the adhesive material in select locations. Identifying marks may also be included on the adhesive material at or near the boundary of the content allowing the label device to identify the boundary for each label. The label device may secure the adhesive material and may guide a cutter assembly to cut, score, perforate, or otherwise physically delineating a label boundary around the content defining a label on the adhesive material. The cutter assembly may be adapted to cut the adhesive material without cutting into or through the backing. The adhesive material may then be released from its secure condition and it may be fed out of the label device. The one or more labels on the adhesive material may then be removed from the backing and freed from the surrounding adhesive material and placed on a box, bottle, instrument, or other item as a label or sticker, for example. In the context of clinical trials, the label device may be used to create labels for drug bottles, kits, instruments or other items on an as-needed basis allowing for issues of delay, waste, and inefficiencies to be avoided.

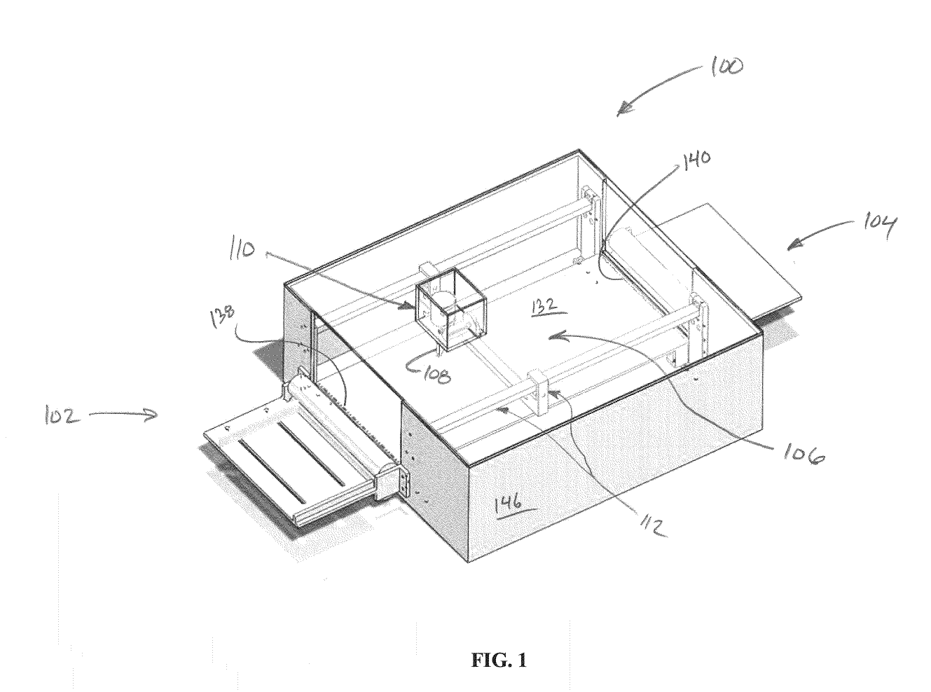

Referring now to FIG. 1, the label device 100 may be configured for creating labels using, for example, a sheet or roll of adhesive material having a backing. The device 100 may be configured for taking in such adhesive material, securing the material, physically delineating a label boundary on the material, and ejecting the material. The label device 100 may include an inlet system 102 and an outlet system 104 leading to and from a label creation area 106. The label creation area 106 may include a delineation element or cutting element 108 configured for cutting an outline of a label in the material. The cutting element 108 may be part of a cutter assembly 110 allowing the cutting element 108 to be actuated. In addition, the cutter assembly 110 may be moveable within the label creation area 106 with a cutter handling system 112. The cutter assembly 110 and/or cutter handling system 112 may include a sensing feature 178 for sensing the location of content on the sheet such that a label may be created at a corresponding location, with a corresponding shape, and with a corresponding size. Each of these particular elements of the device 100 may now be described in more detail.

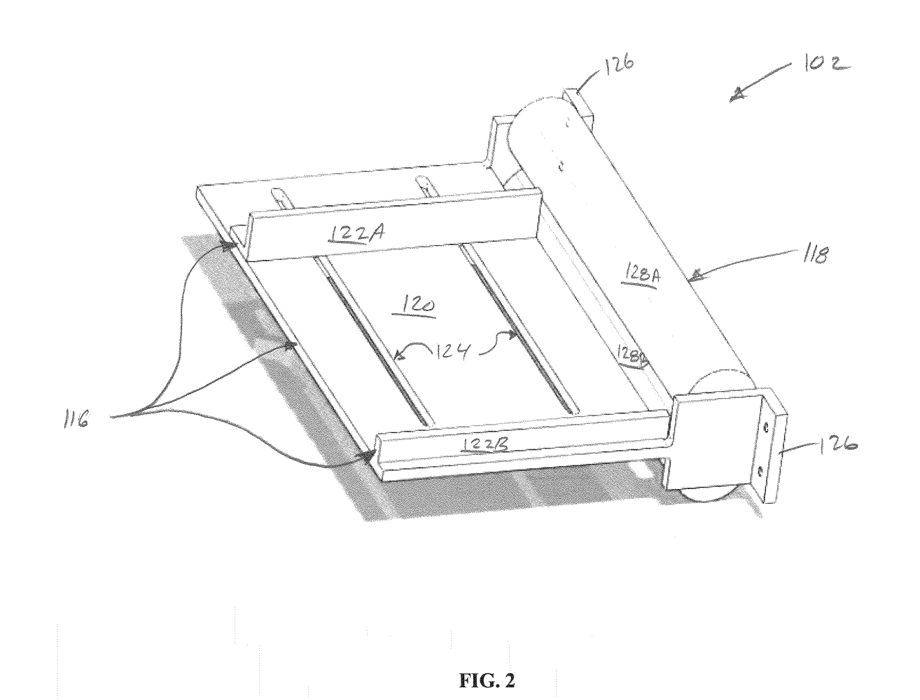

An inlet system 102 is shown in FIG. 2. The inlet system 102 may include an alignment portion 116 and an intake portion 118. The alignment portion 116 may include a tray 120 for holding one or a plurality sheets of label material in a position poised for entering the device or for guiding a ribbon-like portion of material from a roll of adhesive material into the device. The intake portion 118 may be configured for drawing the material from the tray 120 and into the device 100.

The tray 120 may be secured to the label device 100 or the tray 120 may be isolated from the label device 100 and, instead, positioned adjacent to the label device 100, for example. The tray 120 may be relatively planar for placing and/or stacking label material on the tray 120 or for guiding a ribbon-like portion from a roll of material into the device 100. The label material may include a leading edge for entering the device before the remaining portion of the label material, a trailing edge for entering the device after the remaining portion of the label material and two side edges extending between the leading and trailing edges. It is to be appreciated that the trailing edge of the material may be a trailing portion (i.e., not an edge) when the material is in the form of a roll. The tray 120 may include a pair of alignment guides, or fences 122, for guiding the side edges of the label material such that the side edges may be positioned substantially parallel to the direction of travel into and out of the label device 100.

The alignment fences 122 may be positioned on or adjacent the tray 120 and may extend upward from the tray 120 to accommodate a stack of label material, for example. The fences 122 may be stationary fences that are fixed in position relative to the label device 100 or relative to the tray 120 or the fences 122 may be adjustable to accommodate different sizes of label material. In some embodiments one of the fences 122 may be fixed and the other may be adjustable. As shown in FIG. 2, an adjustable fence 122A may be arranged on the surface of the tray 120 and the tray 120 may have adjustment slots 124 in the surface of the tray 120. The adjustment slots 124 may extend across the tray 120 in a direction substantially perpendicular to the direction of travel of the label material. The fence may include registration features for positioning in the adjustment slots 124 and configured to guide the adjustment of the fence 122A along the slots 124, while resisting motion of the fence 122 in the direction along or against the direction of travel.

The intake portion 118 may be positioned between the tray 120 and the label creation area 106 of the device 100 such that the intake portion 118 may draw label material from the tray 120 into the label creation area 106. In some embodiments, the tray 120 may be secured to the device 100 with brackets 126 and the brackets 126 may also support and/or be a part of the intake portion 118. As shown in FIG. 2, the intake portion 118 may include a pair of rollers 128 in contact with one another and configured to rotate opposite directions so as to draw the label material between them. The rollers 128 may have a relatively resilient surface and be positioned to press against one another sufficiently to grasp the label material passing between the rollers 128. The rollers 128 may be operable to draw the label material from the tray 120 and into the label creation area 106 and may be further operable to hold the trailing edge or portion of the label material. That is, after the label material is drawn from the tray 120 and into the label creation area 106, the leading edge of the label material may reach across the label creation area 106 to an outtake portion 130 of an outlet system 104, which may grasp the leading edge or portion and the intake portion 118 may maintain its grasp of the trailing edge or portion. These two intake/outtake portions 118/130 may work together to draw the label material taut across the label creation area 106. In some embodiments, the intake portion 118 may, for example, be adjustable along a vertical elevator allowing the intake portion 118 to pull the trailing edge or portion of the label material downward so as to stretch it across a table 132 of the label creation area 106.

The outlet system 104 may be arranged on the opposite side of the label creation area 106 as the inlet system 102. Like the inlet system 102, the outlet system 104 may include an outtake portion 130 and tray 134. The tray 134 may be relatively planar so as to receive label material exiting the device 100 and allowing the label material to come to rest on the tray 134 and to have consecutive pieces of label material stacked atop one another or to have a continuous roll pass across the tray 134. The tray 134 may include guides or fences and the guides or fences may be the same or similar to the guides or fences on the inlet system tray 120. In other embodiments, the guides or fences may be omitted from the outlet system tray 134.

The outtake portion 130 of the outlet system 104 may also be similar to the intake portion 118 of the inlet system 102. The outtake portion 130 may be configured to receive the leading edge or portion of label material as it is drawn into and across the label creation area 106. The outtake portion 130 may include a pair of rollers 136, for example, that may rotate opposite directions so as to grasp the leading edge or portion of the label material as it passes between the two rollers 136. The two rollers 136 of the outtake portion 130 may have a resilient surface and may be spaced from one another by a distance adapted to compress the resilient surface slightly and, thus, grasp label material as is passes therethrough. Like the intake rollers 128, the outtake rollers 136 may be adjustable along a vertical elevator, for example, such that once the leading edge or portion of the label material is grasped by the rollers 136, the rollers 136 may draw the leading edge or portion downward so as to stretch the label material taut across a table 132 of the label creation area 106. In other embodiments, the intake rollers 128 and the outtake rollers 136 may be configured to pull the label material in opposite directions to draw it taut across the label creation area 106. In this embodiment, for example, the rollers 128/136 may be positioned slightly below the table 132 of the label creation area 106 and guides may be positioned in the label creation area 106 to guide the leading edge or portion of label material to the outtake rollers 136. Once the leading edge is received by the outtake rollers 136, the intake rollers 128 may reverse direction so as to draw the label material taut across the table 132. Still other approaches to drawing the label material taut may be provided.

The label creation area 106 may be arranged between the inlet system 102 and the outlet system 104. The label creation area 106 may include a platform 132 against which the label material may be cut. The platform 132 may be relatively or substantially flat allowing the label material to be drawn across the platform 132 and secured against the platform 132 for cutting. The platform 132 may have a top surface defining a plane and the seam between the intake and outtake rollers 128/136 may be substantially in line with the plane or slightly above the plane while label material is drawn into or out of the label creation area 106. The platform 132 may include an inlet edge 138 positioned adjacent the intake portion 118 of the inlet system 102 and an outlet edge 140 positioned adjacent the outtake portion 136 of the outlet system 104. Each of the inlet edge 138 and the outlet edge 140 may be radiused, chamfered, or otherwise treated such that when the intake portion 118 and outtake portion 130 draw the label material taut across the platform or table 132, the leading edge and trailing edge of the label material is not torn, ripped, or otherwise compromised. The top surface of the platform 132 may include a substantially strong and/or hardened surface so as to resist marring, scratching, cutting, or other surface blemishes. In some embodiments, the platform 132 may be anodized, hardened, or otherwise treated to resist such blemishes.

The label creation area 106 may also include a cutter assembly 110. The cutter assembly 110 may be positioned on a cutter handling system 112 allowing the cutter assembly 110 to be controllably moved throughout the label creation area 106 above the platform 132 such that selected, programmed, or sensed locations may be targeted by the cutter assembly 110. In short, the cutter assembly 110 may include cutting element 108 actuatable in a vertical direction (i.e., perpendicular to the platform surface) to contact the surface of the label material. The cutter assembly 110 may be moveable in one or several directions across the surface of the platform 132 by way of the cutter handling system 112.

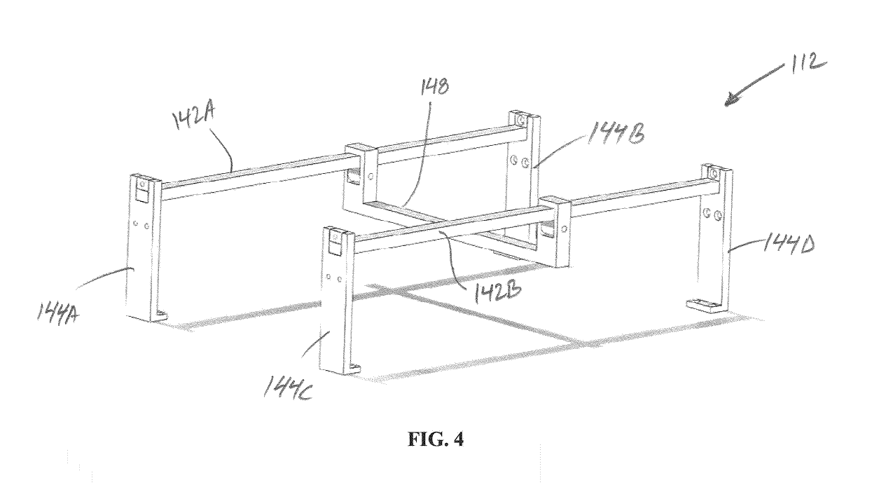

As shown in FIG. 4, the cutter handling system 112 may include a pair of primary rails 142. The primary rails 142 may be arranged above the platform 132 and may extend substantially the full length of the platform 132 from the inlet edge 138 to the outlet edge 140 of the platform 132 and may be arranged on opposite sides of the platform 132. The primary rails 142 may be arranged substantially parallel with one another and may be spaced from one another by a distance substantially equal to or slightly greater than a width of the platform 132 measured perpendicular to the direction of travel of the label material. The primary rails 142 may be supported by a tower 144 on each end thereof. In other embodiments, the device 100 may include a housing 146 and the primary rails 142 may be secured at each end directly to the housing. It is to be appreciated that while the primary rails 142 are arranged parallel with the direction of travel of label material, the primary rails 142 may, instead, be arranged perpendicular to the direction of travel of the label material.

The primary rails 142 may function to support a secondary rail 148 spanning between the two primary rails 142 such that the secondary rail 148 may move along the length of the primary rails 142 and along the length of the device 100. In some embodiments, for example, the secondary rail 148 may include a drive motor having a gear configured to crawl along a rack (i.e., rack and pinion) on the primary rail 142. In some embodiments, the drive motor on the secondary rail 148 may be operable to drive a gear on each of the primary rails 142 so as to resist differential movement between the opposing ends of secondary rail 148. In other embodiments, separate motors may be included and a calibration method may be performed periodically or continuously to assure alignment of the opposing ends of the secondary rail 148. In any of the above cases, the motor or motors may be provided with an optical encoder or other sensory device for determining the position of the motor and/or secondary rail 148 to allow for precise control of the position of the secondary rail 148. The secondary rail 148 may support the cutter assembly 110 and, as such, translation of the secondary rail 148 along the primary rails 142 may function to translate the cutter assembly 110 along the length of the device 100 and along the length of the label creation area 106.

The cutter assembly 110 may be similarly arranged on the secondary rail 148. That is, the cutter assembly 110 may include a motor having a gear for crawling along a gear rack (i.e., rack and pinion) on the secondary rail 148. Accordingly, the motor/gear on the cutter assembly may be operable to translate the cutter assembly 110 across the width of the label creation area 106. Like the motor for moving the secondary rail 148, the motor for moving the cutter assembly 110 may include an optical encoder or other sensor for determining the position of the motor and/or cutter assembly 110. As such, when used together, the motors or motors on the secondary rail 148 and the motor on the cutter assembly 110 may be operable to move the cutter assembly 110 through lines or curves by controlling an X position and a Y position of the cutter assembly 110. It is to be appreciated that while rack and pinion type motion has been described, cable and pulley, plunger and slide, or other mechanical mechanisms may also be used to control the position of the secondary rail 148 and the cutter assembly 110. Still further, while a cartesian coordinate system (i.e., x and y) has been described, other systems including polar coordinates may be used. Moreover, mechanical systems such as a telescoping and radially extending arm may also be used that may be more akin to control in a polar coordinate system. Still other coordinate systems and mechanical systems may be used.

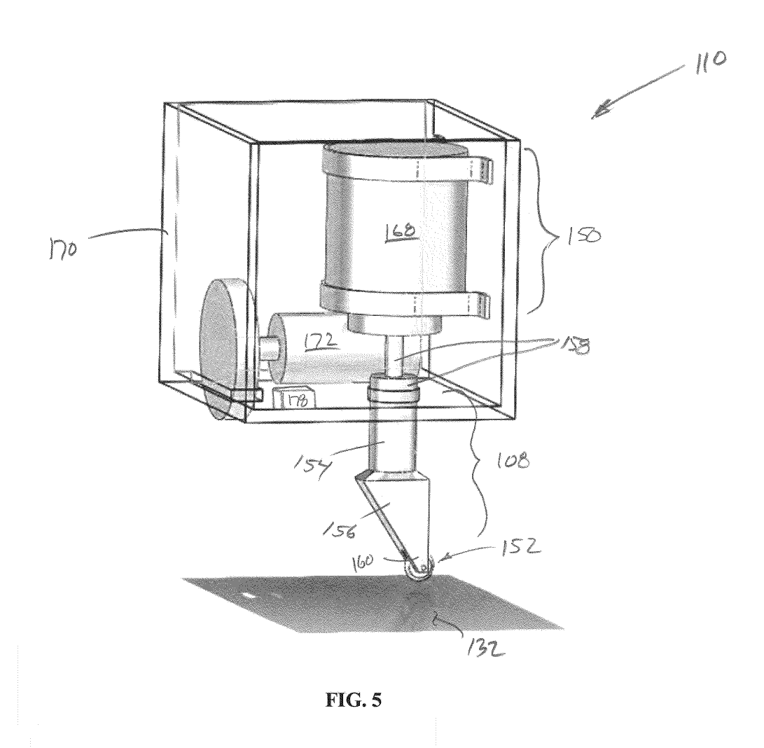

As discussed, and as shown in FIG. 5, the cutter assembly 110 may be moveable along the secondary rail 148 and it may also include an actuation system 150 and cutting element 108. The cutting element 108 may be operable via the actuation system 150 in a vertical direction so as to allow a cutter portion 152 to selectively and controllably contact the surface of the label material and impinge against the label material pressing it against the platform 132 and functioning to cut, perforate, or otherwise physically delineate a label within the boundary of the label material. The cutting element 108 may include a ram portion 154, a mount 156, and a cutter 152. The ram portion 154 may be physically coupled to the actuation system 150 such that actuation of the actuation system 150 is reflected by movement of the cutting element 108. The mount 156 may be physically coupled to the ram portion 154 and may be adapted for holding and securing a cutter 152 such as a knife blade, roller blade, or other cutting or perforating element, for example. As shown, the ram portion 154 may be substantially cylindrical with a relatively large diameter so as to drive the mount 156 and the cutter 152 in response to the actuation system 150 with little to no deflection. The cylindrical shape of the ram 154 may allow the ram 154 to engage a bore of the actuation system 150 such that the ram 154, mount 156, and cutter 152 may be rotatable about a vertical axis relative to the actuation system 150 such that the cutting element 108 may track similar to a shopping cart wheel. In other embodiments the bore may be coupled to the actuating element 158 of the actuation system, as shown. The mount 156 may be a substantially thick piece of material similar to the ram 154 so as to resist deflection under force from the actuation system 150. Near a bottom edge of the mount 156, the mount 156 may include a pair of substantially rigid tabs 160 extending from the mount 156 and adapted for placement of the cutter 152 therebetween. The cutter 152 may include a wheel blade, for example, and an axle 162 may extend between the tips of the mount 154 to secure the wheel blade to the mount 156 and expose a portion of the cutter 152 between the mount tabs 160. The mount 156 may extend downwardly from the ram 154 and may be shaped to cause the cutter 152 to be offset from a vertically extending axis 164 of the ram 154. For example, as shown, the mount 156 may be shaped as a right triangle with the base of the triangle centered on the ram 154 and the apex of the triangle near the bottom edge and having the cutter 152 secured near the apex of the triangle. As such, the cutter 152 may be offset by a distance 166 from the center of the ram 154 by approximately half of the width of the base of the triangle. Accordingly, as the cutter assembly 110 moves, the cutter 152 may engage the label material causing the cutting element 108 (i.e., ram 154, mount 156, and cutter 152) to pivot about the vertical axis 164 of the ram 154 and trail the cutter assembly 110 through its route of motion.

The actuation system 150 may be adapted to advance the ram 154 portion of the cutting element 108 to force the cutter 152 against the label material. The actuation system 150 may be calibrated together with the cutter 152 such that the cutter 152 cuts, perforates, or otherwise delineates the location of a label and sufficient integrity of the backing on the label material is maintained. That is, the cutter 152 may be pressed against the surface of the label material causing the cutter 152 to cut through the adhesive portion, but may stop short of cutting through the backing on the label material.

In some embodiments, as shown in FIG. 5, the actuation system 150 may include a solenoid 168. The cutter assembly 110 may include a housing or frame 170 coupled to the motor 172 such that translation of the motor 172 is reflected by the housing 170. The solenoid 168 may be coupled to the housing 170 and the ram portion 154 of the cutting element 152 may be coupled to the solenoid 168. The solenoid 168 may be actuatable via an applied voltage. In some embodiments, the solenoid 168 may be positioned above the platform 132 and the applied voltage may be monitored and/or controlled such that the amount of force applied to the label material at the cutter 152 is known. In this embodiment, particular cutters 152 may be associated with particular forces such that a suitable amount of force may be selected to cut through the label material while leaving the backing material substantially intact. In other embodiments, a hard-stop solenoid 158 may be employed. In this embodiment, the cutter assembly 110 may be positioned at a particular distance above the platform 132 and the solenoid 168 may be actuatable via an applied voltage. However, unlike the known force method above, a hard-stop may be employed such that the cutter 152 is positioned at particular distance proximate to the platform 132. That is, for example, the distal edge of the cutter 152 may be positioned such that it is at or slightly below and into the backing material so as to be sure to cut through the adhesive sheet portion of the label material, but avoid penetrating fully through the backing material. Where the backing material is slightly resilient, the position of the cutter 152 being slightly below the surface of the backing may not result in cutting into the backing material.

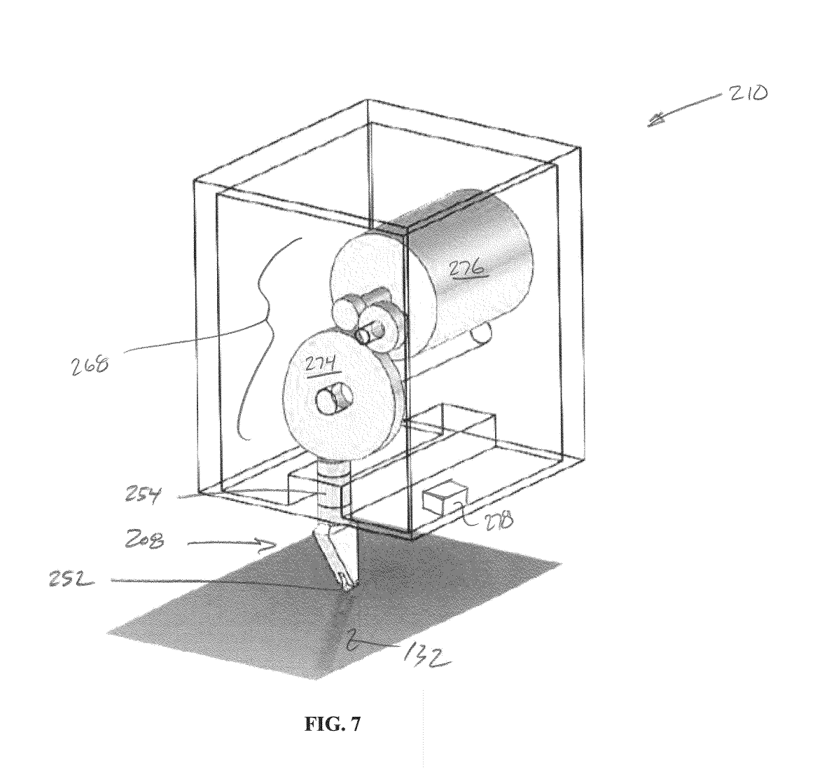

Referring now to FIG. 7, an alternative cutting assembly 210 with an alternative actuation system in the form of a cam system 268 is provided. The cam system 268 may controllably advance the cutting element toward the label material. As shown, the cam system 268 may include a guide for positioning of the cutting element 208 below a cam wheel 274. The guide may be configured to allow the ram 254 portion of the cutting element 208 to rotate and move up and down relative to the platform 132 but may maintain the ram 254 in alignment with the cam wheel 274. A motor and gear assembly 276 may be provided for rotating the cam wheel 274. The cam wheel 274 may be shaped such that as it rotates, it forces the ram portion 254 of the cutting element 208 toward the platform 132. The cam wheel 274 geometry may, thus, be designed and selected such that particular angular rotations of the cam wheel 274 will cause the cutting element 208 to advance toward the platform a particular distance such that very precise vertical positioning of the cutter 252 may be implemented allowing for adjustments in the cutter depth. By way of comparison, this cam embodiment may allow for control of vertical positioning without regard to the amount of force that is applied, while the above solenoid embodiment may allow for control of the amount of force that is applied without regard to the vertical positioning. One or both of these approaches may be suitable depending on the type of material that is being used, the type of blade that is being implemented and other factors. Still further, in embodiments focused on vertical positioning, sensors may be provided to monitor the force resulting in the system so as to avoid overly stressing any parts or substrates.

As mentioned, the cutter assembly 110/210 may be moveable in a lateral direction by moving along the secondary rail 148 and in a longitudinal direction via movement of the secondary rail 148 along the primary rails 142. Accordingly, the cutter assembly 110/210 may be moveable in a Cartesian coordinate system. The movement of the cutter assembly 110/210 may be controlled by a central processing unit that accesses a computer readable storage medium having programmed label geometries stored therein. For example, a storage file may be provided having cutter assembly routes defined by consecutive X,Y positions. A central processing unit may read the storage file and control the actuation system together with the motor on the secondary rail 148 and the motor in the cutter assembly 110/210 to guide the cutter assembly 110/210 through the various X,Y, positions. The passive swiveling of the cutter 152/252 may allow the cutter 152/252 to track with the movement of the cutter assembly 110/210 and physically delineate the label locations.

In some embodiments, the location and positioning of the cutter assembly 110/210 may be controlled by sensors 178/278 adapted to read the incoming label material. As shown, the sensors 178/278 may be arranged on the cutter assembly 110/210 at some defined location relative to the cutter. In other embodiments, the sensors 178/278 may be arranged at other locations including on the housing of the device 100, on the inlet 102 or on the outlet 104. In still other embodiments, the sensors 178/278 may be arranged on the secondary rail, the primary rail on a ceiling of the device 100, in the platform 132, or in other locations. Still further, one or a plurality of sensor may be provided to allow for more fully and/or quickly identifying surface content of the material for use as described below. Still other arrangements may be provided.

In some embodiments, the label material may be pre-printed with text, icons, pictures, logos, or other label content. The incoming label material may also include a grouping of black dots or other identifying marks readable by the sensors 178/278 and located in an unused area of the label material, for example. The sensors 178/278 may locate the identifying mark and use it to obtain location information from a computer file having label text information, formatting, or other content information. For example, the device 100 may be in communication with a computer used to print the label information on the label material and the file or files associated with printing the label may be accessible by the device 100 and identifiable based on the identifying information read from the label material. In other embodiments, single files or batch files may be loaded onto the device 100 allowing the device 100 to identify content locations based on the identifying marks on the label material.

In other embodiments, each piece of content or groups of content may include identifying marks arranged at or near the location of the label edge. The sensors 178/278 may be in the form of an optical eye, for example, that the central processing unit uses to identify the location of the label or labels on the label material. The central processing unit may then guide the cutter assembly through routes defined by the identifying marks. It is to be appreciated that the marks themselves may not be on the boundary of the label, but may be slightly outside the boundary of the label as defined by the programming. As such, the identifying marks may be offset for example from the label boundary by a particular distance, or the identifying marks may be in theoretical sharp corners of the label and the corners of the label may be radiused such that the identifying marks are not included on the label. Still other techniques for including identifying marks that are sensed by the system, but not included on the label may be provided. In still other embodiments, the marks or some portion of the marks may be included on the label.

It is noted that while several embodiments of a label device have been shown and described, no particular element of any of the described label devices should be restricted to the embodiment with which it has been described. That is, many of the elements may be combined with, added to, or used with embodiments of the other label devices including those described in related or incorporated applications or documents.

While the present disclosure has been described with reference to various embodiments, including preferred embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A label device, comprising:
an inlet system;
an outlet system; and
a label creation area arranged between the inlet system and the outlet system, comprising:
a platform; and
a cutter assembly arranged above the platform and configured to move through a programmed route to physically delineate a label on a sheet of label material backed by the platform.

2. The device of claim 1, wherein the inlet system and outlet system are configured for drawing the label material taut across the platform.

3. The device of claim 2, wherein the inlet system and outlet system are each operable along a vertical elevator to draw the label material taut across the platform.

4. The device of claim 3, wherein the inlet system and the outlet system include a pair of rollers.

5. The device of claim 1, further comprising a cutter handling system including a plurality of rails.

6. The device of claim 5, wherein the plurality of rails include a pair of primary rails and a secondary rail operable to translate along the pair of primary rails.

7. The device of claim 6, wherein the cutter assembly is supported by the secondary rail and operable to translate along the length of the secondary rail.

8. The device of claim 7, wherein the cutter assembly includes a housing and a motor is coupled to the housing for translating the cutter assembly along the secondary rail.

9. The device of claim 8, wherein a rack and pinion is provided and configured to allow the motor to control the position of the housing along the length of the secondary rail.

10. The device of claim 1, wherein the cutter assembly includes a cutting element passively engage therewith so as to rotate and track with the position of the cutter assembly.

11. The device of claim 10, wherein the cutting element includes a ram with a longitudinal axis and a cutter having a position offset from the longitudinal axis.

12. The device of claim 11, wherein the cutter is a cutting wheel.

13. The device of claim 1, wherein the cutter assembly includes an actuation system for actuating the cutting element to engage the label material.

14. The device of claim 13, wherein the actuation system includes a solenoid.

15. The device of claim 14, wherein the solenoid is a variable force solenoid controllable by an applied voltage.

16. The device of claim 14, wherein the solenoid includes a hard stop solenoid.

17. The device of claim 13, wherein the actuation system includes a cam system.

18. The device of claim 17, wherein the cutter assembly includes a guide for maintaining the alignment of the cutting element with a cam wheel.

19. The device of claim 18, wherein the cutter assembly includes a motor for controllably rotating the cam wheel to adjust the vertical position of the cutter on the cutting element.

20. The device of claim 1, wherein the programmed route is a pre-programmed route.

21. The device of claim 1, wherein the cutter assembly includes a sensor for identifying label locations on the label material.

22. The device of claim 21, wherein the programmed route is defined by the sensor identified label locations.
